(19) United States
(12) Patent Application Publication
(10) Pub. No.: US 2026/0107917 A1
(43) Pub. Date: Apr. 23, 2026

(54) SLOW-LIQUID-FEEDING BOWL FOR PETS

(71) Applicant: Shenzhen Xuanyu Technology Co., Ltd., Shenzhen City (CN)

(72) Inventor: Ligang DING, Shenzhen City (CN)

(73) Assignee: Shenzhen Xuanyu Technology Co., Ltd., Shenzhen City (CN)

(21) Appl. No.: 19/423,758

(22) Filed: Dec. 17, 2025

(30) Foreign Application Priority Data
Jul. 9, 2025 (CN) 202521432482.8

(51) Int. Cl. A01K 5/01

(52) U.S. Cl. CPC A01K 5/0108; A01K 5/0114

(57) ABSTRACT

The present application discloses a slow-liquid-feeding bowl for pets, comprising a holding container, a licking compartment, and a licking member. The licking compartment is covered above the holding container and detachably connected thereto. The licking member is located inside the holding container and rotates on it. The licking compartment is provided with a licking hole, through which the top of the licking member passes, allowing the ball to rotate at the hole. The outer wall of the licking member is provided with several groove cavities. The detachably connected holding container and licking compartment facilitate disassembly and cleaning, reducing bacterial growth. The groove cavities on the licking member’s surface increase the adhesion of liquid food, slowing down feeding speed and preventing health issues caused by rapid eating.

### CROSS-REFERENCE TO RELATED APPLICATIONS

The present application claims priority to Chinese Patent Application No. 202521432482.8, filed on July 9, 2025, the content of which is incorporated herein by reference in its entirety.

### TECHNICAL FIELD

The present application belongs to the technical field of pet supplies, and particularly relates to a slow-liquid-feeding bowl for pets.

### BACKGROUND

With the growth of the pet snack market, pet enthusiasts have higher requirements for pet health. Liquid foods such as bone broth and yogurt have attracted attention due to their high nutritional value and health benefits, but ordinary yogurt is thin, making it difficult for pets to lick, and may also burden their digestive systems. During the licking process, pets may easily overturn the bowl, eat too quickly, or make subsequent cleaning inconvenient, leading to health issues.

Therefore, a specialized slow-liquid-feeding bowl for pets is needed to hold nutritious soups, yogurt, and other liquid foods suitable for pets.

### SUMMARY

An embodiment of the present application provides a slow-liquid-feeding bowl for pets to solve the problems in the prior art.

The embodiment of the present application adopts the following technical solution: a slow-liquid-feeding bowl for pets, including a holding container, a licking compartment and a licking member. The licking compartment is covered above the holding container and detachably connected thereto, and the licking member is located inside the holding container and rotates on the holding container. The licking compartment is provided with a licking hole, and a top of the licking member passes through the licking hole, allowing the ball to rotate at the licking hole.

Further, the licking member is a sphere, and an outer wall of the sphere is provided with several groove cavities.

Further, the licking member is a cylinder, and an outer wall of the cylinder is provided with a plurality of groove cavities.

Further, the holding container is provided with a holding chamber. The bottom of the holding chamber is provided with a rotating groove for the licking member to rotate.

Further, a side wall of the inner bottom of said holding chamber is provided with a plurality of circularly arranged placing ribs, and the placing ribs are located at a side of the rotating groove.

Further, the licking compartment has a frustum structure, a top of the licking compartment is an inwardly concave structure forming a concave placing cavity for holding liquid food, and the licking hole is located at a bottommost end of the center of the licking compartment.

Further, the licking compartment has a placing space inside for accommodating the holding container, an inner wall of the placing space is provided with a plurality of upper limit bosses arranged at equal intervals and a plurality of lower limit bosses arranged at equal intervals. The upper limit bosses and the lower limit bosses are alternately arranged with respect to each other, and an outer wall of the holding container is provided with circular ribs that are engaged with the plurality of upper limit bosses and the plurality of lower limit bosses.

Further, a highest point of the top of the licking compartment is provided with two drainage holes at the concave placing cavity, and the drainage holes are located above the holding container.

The above at least one technical solution adopted in the embodiment of the present application can achieve the following beneficial effects:

First, the detachably connected holding container and licking compartment facilitate disassembly and cleaning, reducing bacterial growth; the groove cavity on the surface of the licking member increases the adhesion of liquid food such as yogurt, slowing down the eating speed and preventing health issues caused by pets eating too quickly.

Second, the inclined structure of the placing ribs cooperates with the rotating groove to guide the stable rolling of the licking member while directing liquid food such as yogurt to the surface of the ball. The scale lines on the inner side wall of the holding chamber allow owners to precisely control the feeding amount, meeting the nutritional needs of pets.

Third, the square frustum and concave design of the licking compartment promote the convergence of liquid food such as yogurt toward the center, making it easier for pets to lick; the combination of the rotating plates and threaded sections of the holding container provides two convenient methods for adding liquid food; the top drainage holes ensure smooth reflux of excess liquid during yogurt filling and licking. These designs effectively solve issues such as easy spillage, difficulty in cleaning, and unscientific feeding of ordinary yogurt bowls, balancing practicality and convenience, significantly improving pets’ eating experience and health management level.

### BRIEF DESCRIPTION OF DRAWINGS

The drawings described here are provided to further understand the present application, constituting a part of the present application. The schematic embodiments and descriptions of the present application are used to explain the present application and do not constitute an improper limitation of the present application. In the drawings:

FIG. 1 is a schematic perspective view of the three-dimensional structure of the present application;

FIG. 2 is an exploded perspective view according to Embodiment 1 of the present application;

FIG. 3 is a schematic perspective view where the sphere is located inside the holding container according to Embodiment 1 of the present application;

FIG. 4 is a schematic perspective view of the holding container according to Embodiment 1 of the present application;

FIG. 5 is a first schematic perspective view of the holding container according to Embodiment 1 of the present application;

FIG. 6 is a second schematic perspective view of the holding container according to Embodiment 1 of the present application;

FIG. 7 is a schematic perspective view according to Embodiment 2 of the present application;

FIG. 8 is an exploded schematic perspective view according to Embodiment 2 of the present application;

FIG. 9 is a schematic diagram showing a sphere located inside a receiving box in Embodiment 2 of the present application;

FIG. 10 is a schematic perspective view of the holding container according to Embodiment 2 of the present application;

FIG. 11 is Schematic perspective view I of the holding container according to Embodiment 2 of the present application;

FIG. 12 is Schematic perspective view II of the holding container according to Embodiment 2 of the present application;

FIG. 13 is a cross-sectional view according to Embodiment 1 of the present application;

FIG. 14 is a cross-sectional view according to Embodiment 2 of the present application.

### REFERENCE SIGNS

Holding Container 1, Holding Chamber 11, Placing Rib 12, Rotating Groove 13, Circular Rib 15, Licking Compartment 2, Licking Hole 21, Concave Placing Cavity 22, Placing Space 23, Upper Limit Boss 24, Lower Limit Boss 25, Drainage Hole 26, Licking member 3, Groove Cavity 31.

### DESCRIPTION OF EMBODIMENTS

To clarify the purpose, technical solutions, and advantages of the present application, the following will describe the technical solutions of the present application clearly and completely in conjunction with specific embodiments and accompanying drawings. Obviously, the described embodiments are only a part of the present application, not all of them. Based on the embodiments of the present application, all other embodiments obtained by ordinary technicians in the field without creative labor shall fall within the protection scope of the present application.

The following combines the drawings to detail the technical solutions of a slow-feeding bowl for pet liquid food provided by various embodiments of the present application.

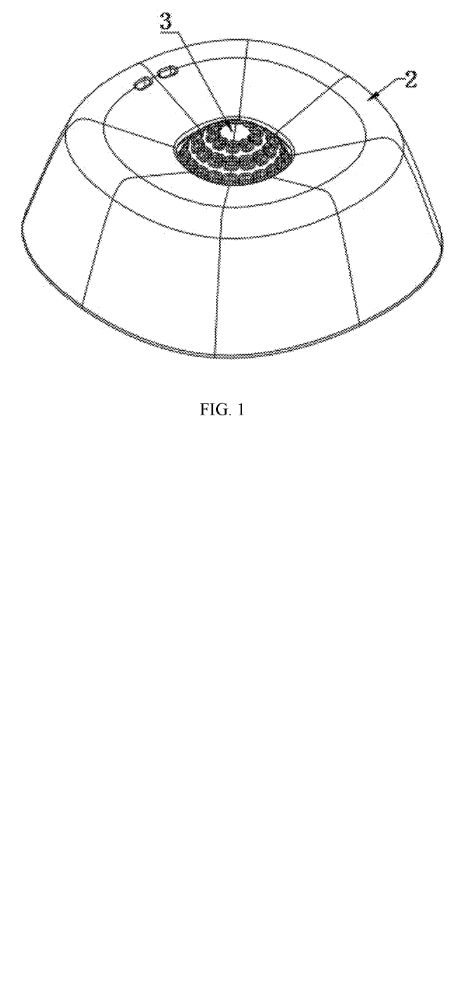

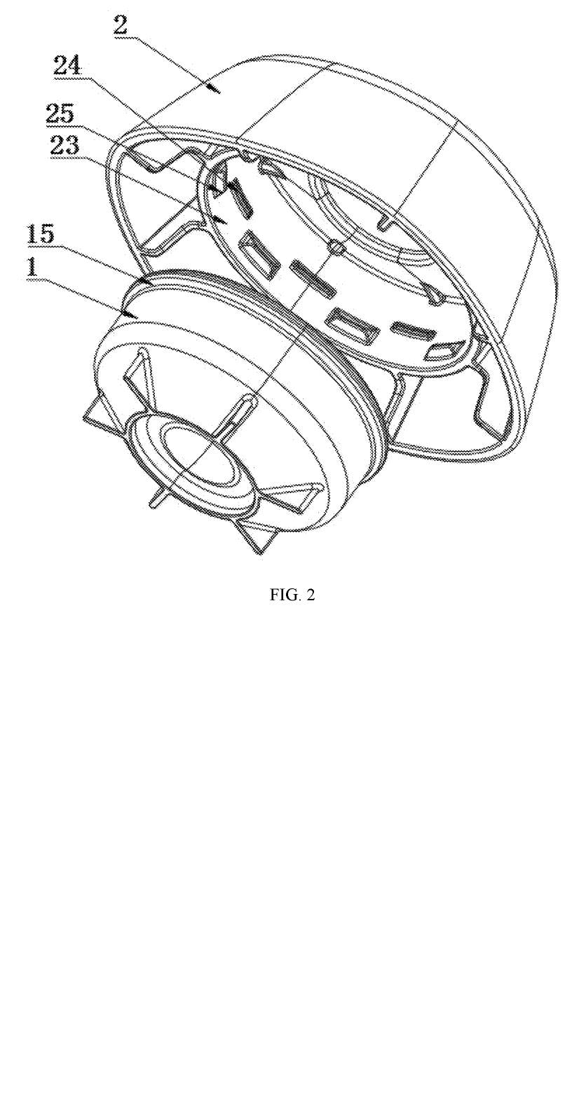

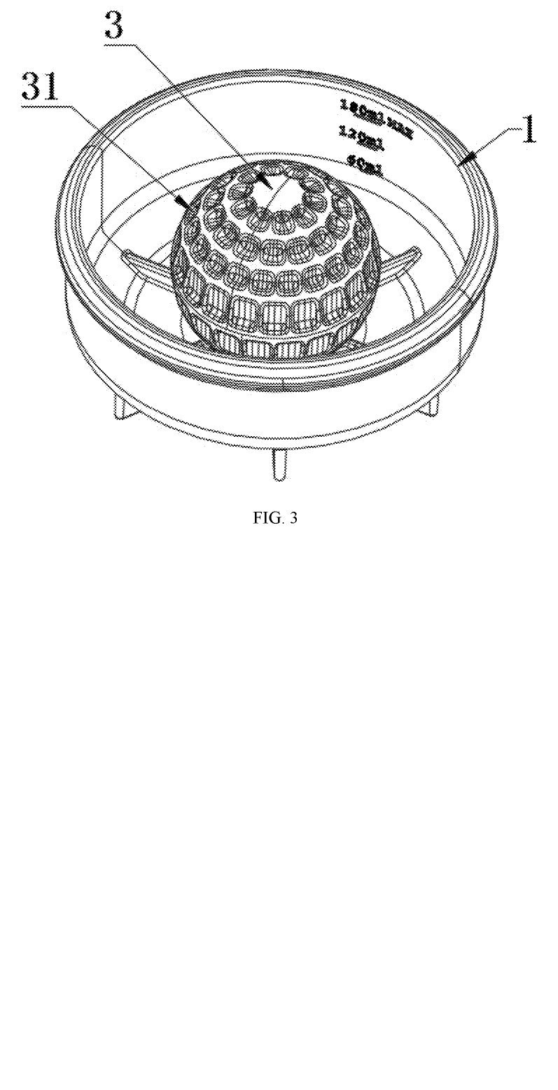

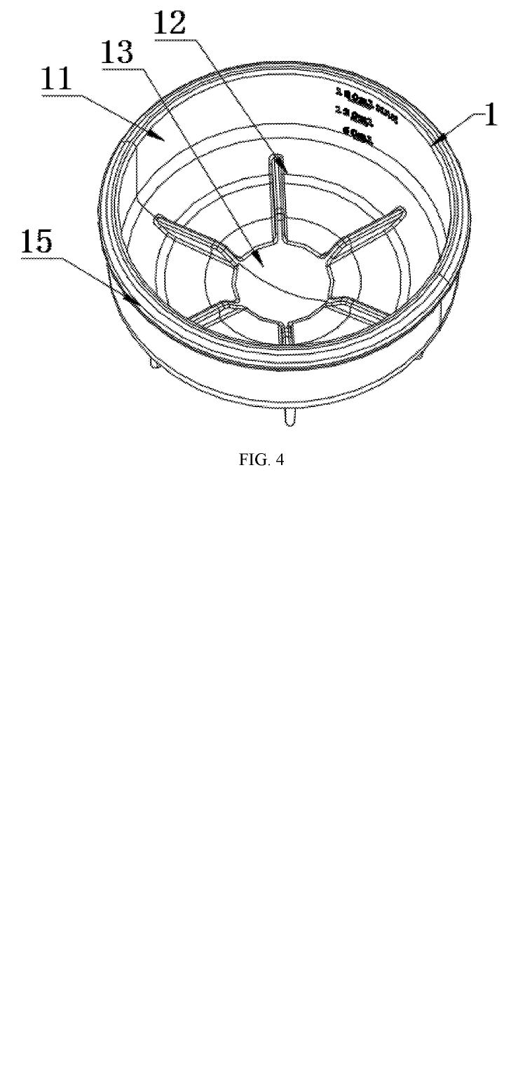

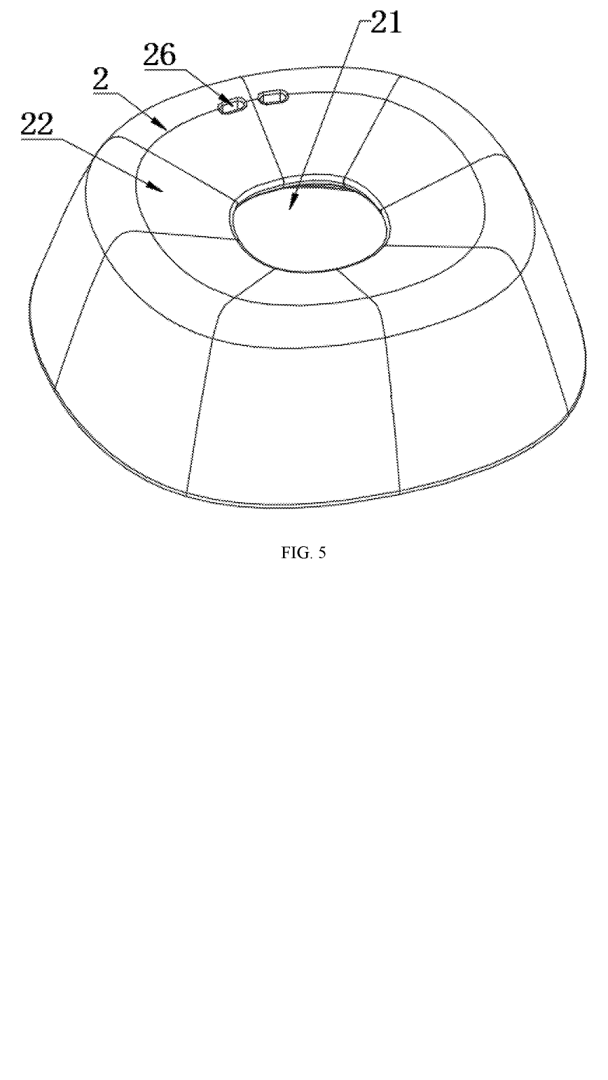

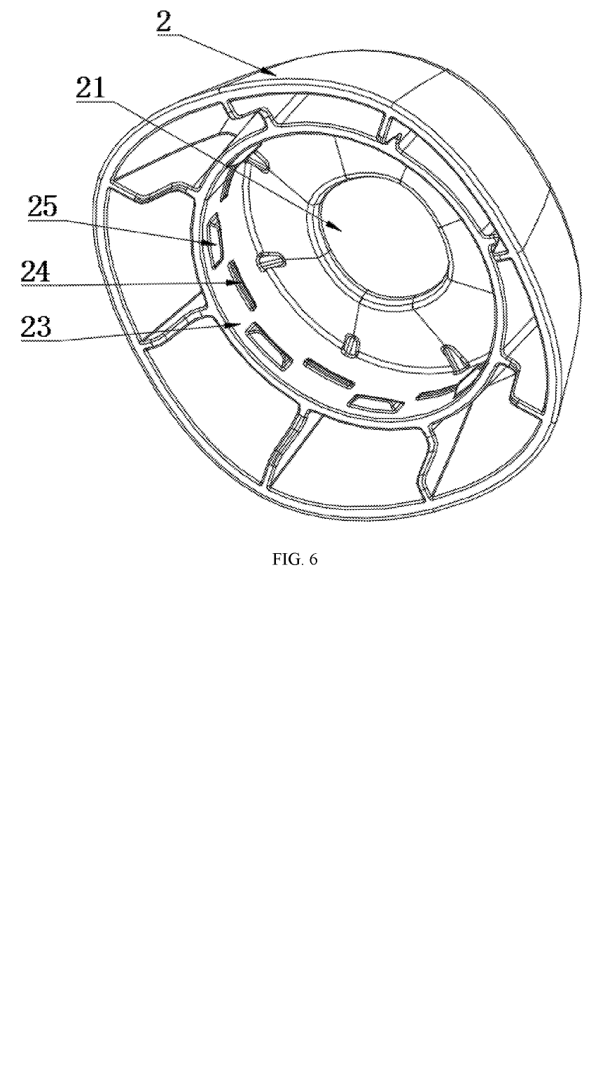

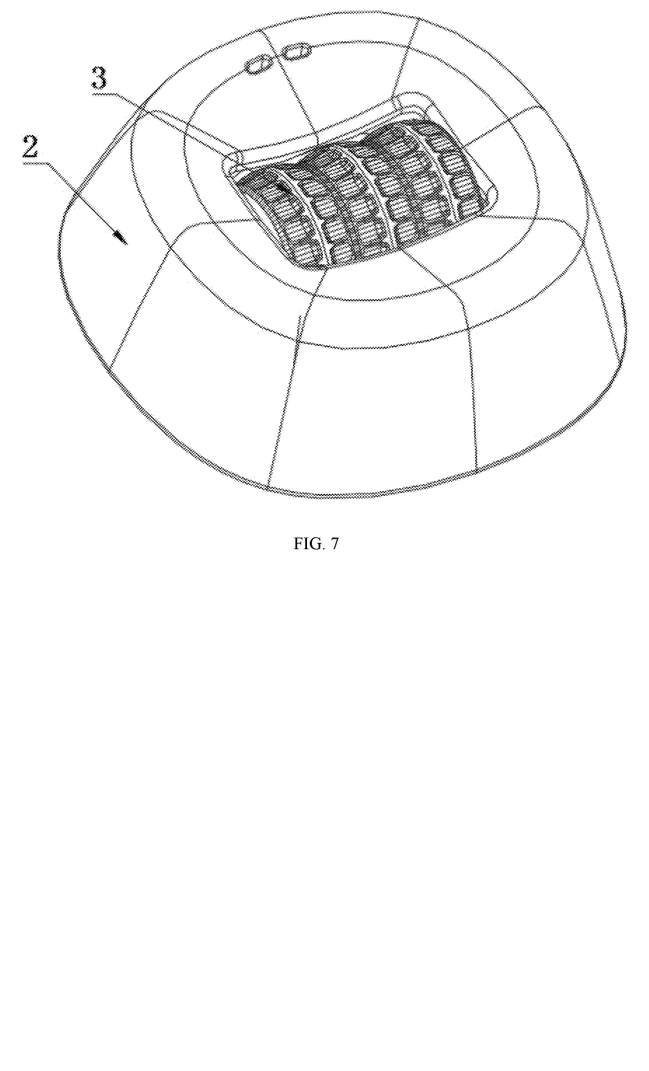

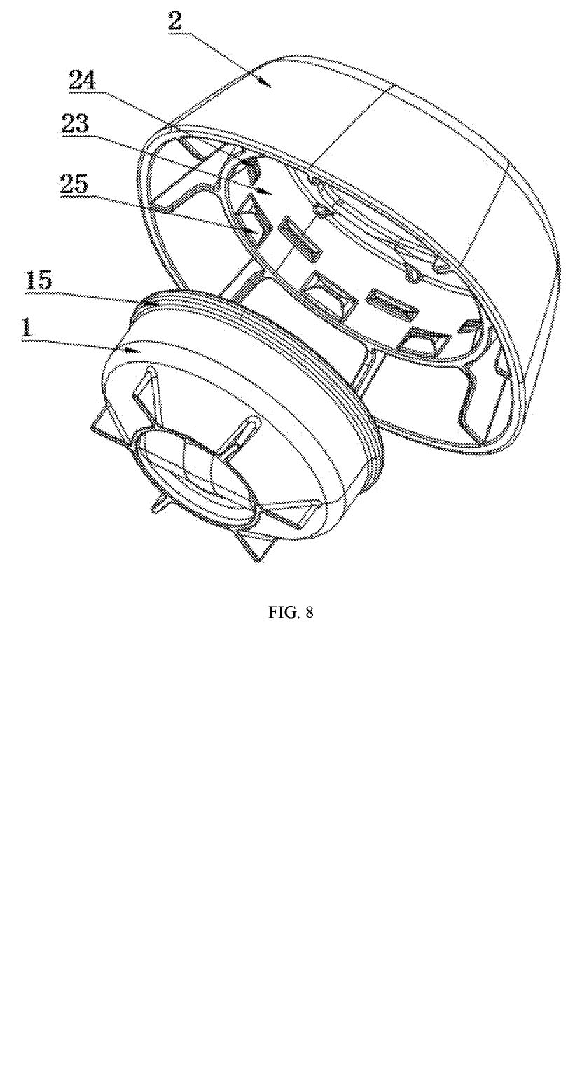

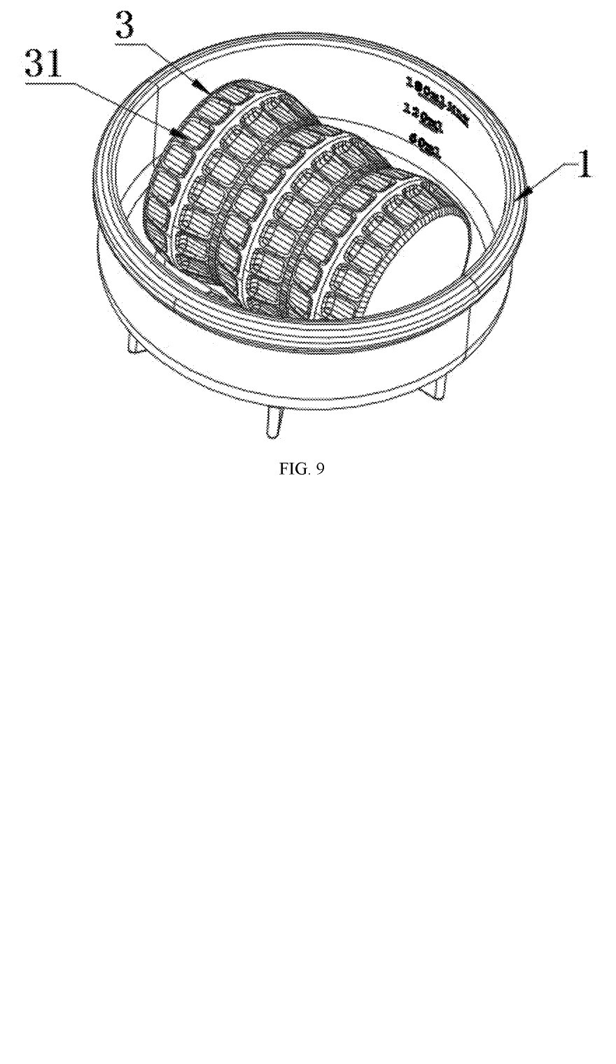

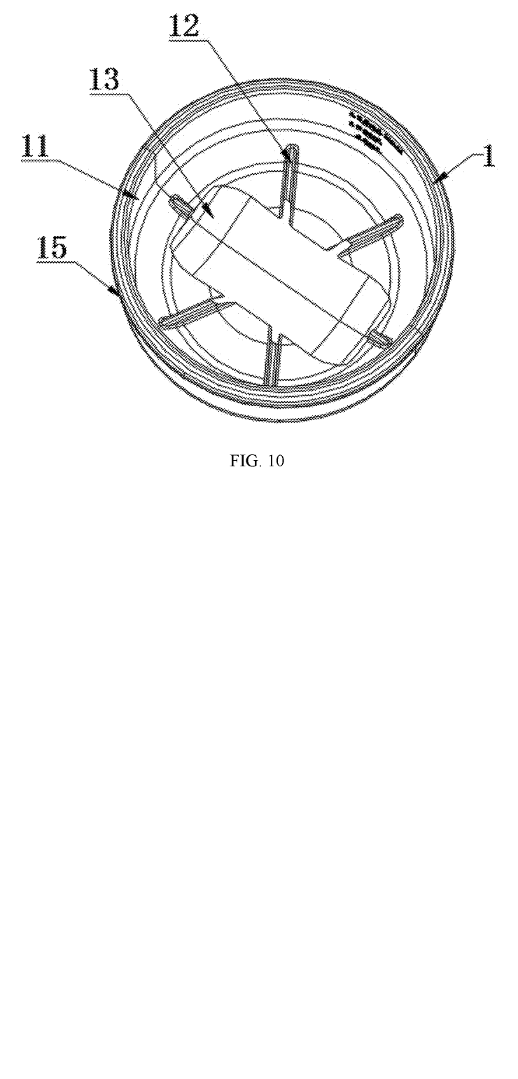

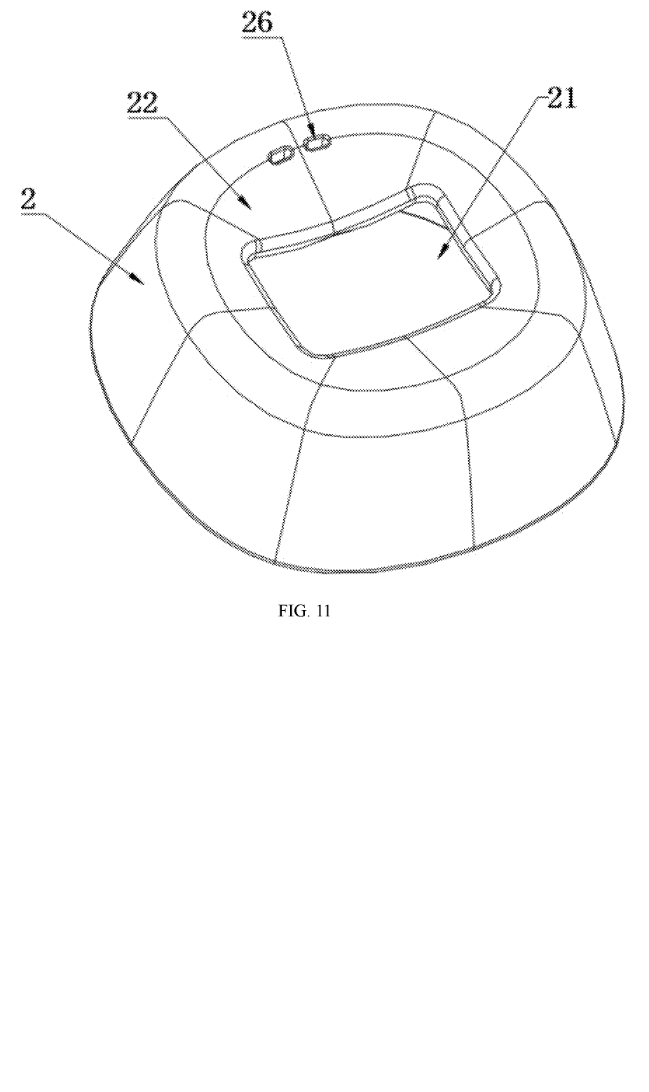

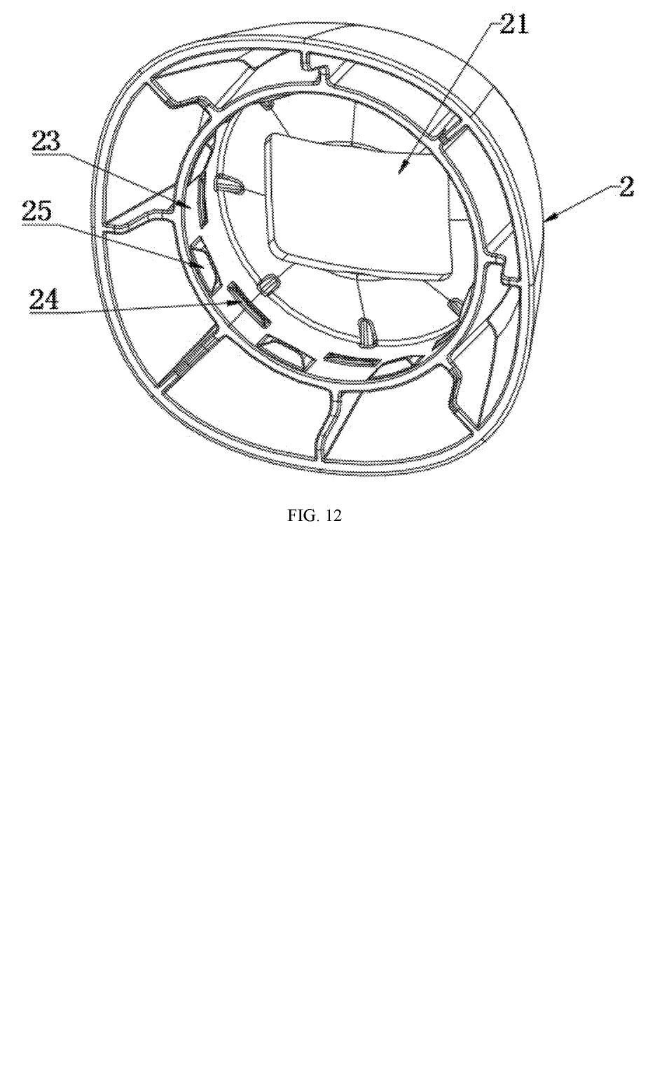

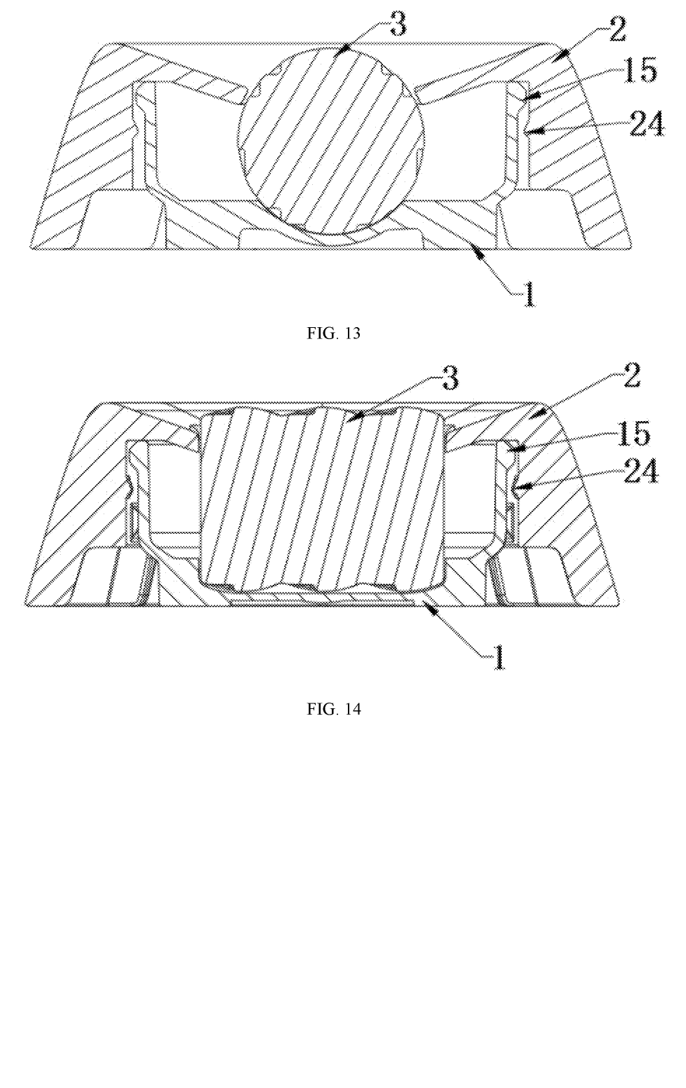

Referring to FIGS. 1 to 14, the embodiment of the present application provides a slow-feeding bowl for pet liquid food, including a holding container 1, a licking compartment 2 and a licking member 3. The licking compartment 2 is covered above the holding container 1, detachably connected thereto. The licking member 3 is located inside the holding container 1 and rotates thereon. The licking compartment 2 has a licking hole 21, and the top of the licking member 3 passes through the licking hole 21, rotating at the licking hole 21.

Working principle: open the licking compartment 2, place yogurt in the holding container 1, then install the licking compartment 2 onto the holding container 1. The pet licks the licking member 3, causing it to rotate within the holding container 1 and the licking hole 21. The rotation of the licking member 3 lifts the liquid food in the holding container 1 through multiple groove cavities 31, allowing the pet to lick yogurt or other liquid food.

### Embodiment 1:

Specifically, the licking member 3 is spherical in shape, and a number of groove cavities 31 are provided on the outer wall of the spherical licking member. The spherical shape offers less rotational resistance, enabling it to accommodate pets of smaller sizes. It also provides more feeding directions, enhancing convenience of use.

### Embodiment 2:

Specifically, the licking member 3 is cylindrical in shape, and a number of groove cavities 31 are provided on the outer wall of the cylindrical licking member. The cylindrical shape allows the pet to consume more liquid food within the same feeding time and consume more liquid food given the same product height.

The three-dimensional structure of the groove cavities 31 forms countless "food-storing pits." When liquid food such as yogurt is applied to the surface of the licking member 3, it embeds into the groove cavities 31, preventing rapid slippage due to the ball’s rotation or pet licking. The presence of groove cavities 31 makes the surface of the licking member 3 no longer smooth, requiring pets to repeatedly scrape and delve into the grooves to obtain food, thereby forcibly slowing down their eating speed. This is particularly important for fast-eating pets, such as puppies or large dogs, as it reduces issues like choking, vomiting, or gastric dilation caused by rapid eating.

Specifically, the holding container 1 is equipped with a holding chamber 11. The inner bottom sidewall of the holding chamber 11 has a plurality of circularly distributed placing ribs 12. The inner bottom of the holding chamber 11 features a rotating groove 13 for the licking member 3 to rotate. The placing ribs 12 is located at the side of the rotating groove 13. The plurality of circularly distributed placing ribs 12 form a "track"-like guiding system. When the pet licks the licking member 3, the placing ribs 12 allow smoother rolling in the rotating groove 13 through friction and geometric guidance, preventing jamming due to uneven force. The slope of the inclined placing ribs 12 acts as a "diversion channel." When liquid food like yogurt is poured into the holding chamber 11, the placing ribs 12 direct the liquid near the rotating groove 13, ensuring the food adheres more concentratedly to the surface of the licking member 3.

Specifically, the licking compartment 2 has a frustum structure. The top of the licking compartment 2 is an inwardly concave structure forming a concave placing cavity 22 for yogurt placement. The licking hole 21 is located at the bottommost end of the licking compartment 2’s center.

The frustum structure combined with the concave top design forms a concave placing cavity 22 resembling a "funnel." This shape ensures that liquid food like yogurt, carried by the rotating licking member 3 into the concave placing cavity 22, naturally converges toward the center due to gravity, preventing the liquid food from flowing along the walls or accumulating in corners. This keeps the food concentrated in areas easily accessible to pets. The licking hole 21 is located at the lowest point of the licking compartment 2, maximizing convenience for pets during feeding. When licking, pets need not struggle to find the liquid food—simply aligning with the central licking hole 21 suffices.

Specifically, the licking compartment 2 has a placing space 23 for accommodating the holding container 1. The inner wall of the placing space 23 is provided with a plurality of upper limit bosses 24 arranged at equal intervals and a plurality of lower limit bosses 25 arranged at equal intervals. The plurality of upper limit bosses 24 and the plurality of lower limit bosses 25 are alternately arranged with respect to each other. The outer wall of the holding container 1 has circular ribs 15 that are engaged with the plurality of upper limit bosses 24 and the plurality of lower limit bosses 25.

The following is the methods for adding liquid food like yogurt: the entire slow-liquid-feeding bowl for pets is lifted, the licking member 3 is pressed downward, causing the holding container 1 to slide down from the licking compartment 2, so that the circular ribs 15 move from above the plurality of upper limit bosses 24 to between the plurality of upper limit bosses 24 and the lower limit bosses 25, creating a displacement gap between the position of the holding container 1 and the licking compartment 2 without complete separation. The movement of the holding container 1 lowers the licking member 3 from the licking hole 21, exposing the hole. Liquid food like yogurt can then be poured directly through the licking hole 21 into the holding chamber 11, and the licking compartment 2 will also be locked onto the holding container 1, at which moment the licking compartment 2 is placed at a high position for adding liquid food.

After filling, the licking compartment 2 is pressed downward, causing the circular ribs 15 to move from between the upper limit bosses 24 and the lower limit platform 25 to above the upper limit bosses 24, thereby locking the licking compartment 2 onto the holding container 1. The licking member 3 will then be exposed upward through the licking hole 21, placing the licking compartment 2 at a low position for pet licking.

Specifically, the highest point of the top of the licking compartment 2 features drainage holes 26 at the concave placing cavity 22, and the drainage holes 26 are located above the holding container 1.

The drainage hole 26 allows cleaning water to flow into the holding container 1. After cleaning, the device is inverted, and the highest-positioned drainage hole 26 will be flipped to the lowest position to drain residual water, enabling cleaning and drying without disassembly.

The above descriptions are merely embodiments of the present application and are not intended to limit it. For those skilled in the art, the present application may undergo various modifications and changes. Any amendments, equivalent replacements, or improvements made within the spirit and principles of the present application shall fall within the scope of its claims.

What is claimed is:

1. A slow-liquid-feeding bowl for pets, comprising a holding container (1), a licking compartment (2) and a licking member (3), wherein the licking compartment (2) is covered above the holding container (1) and detachably connected thereto, and the licking member (3) is located inside the holding container (1) and rotates on the holding container (1);
the licking compartment (2) is provided with a licking hole (21), a top of the licking member (3) passes through the licking hole (21), allowing the licking member (3) to rotate at the licking hole (21).

2. The slow-liquid-feeding bowl for pets according to claim 1, wherein the licking member (3) is a sphere.

3. The slow-liquid-feeding bowl for pets according to claim 2, wherein an outer wall of the sphere is provided with a plurality of groove cavities (31).

4. The slow-liquid-feeding bowl for pets according to claim 1, wherein the licking member (3) is a cylinder.

5. The slow-liquid-feeding bowl for pets according to claim 4, wherein an outer wall of the cylinder is provided with a plurality of groove cavities (31).

6. The slow-liquid-feeding bowl for pets according to claim 1, wherein the holding container (1) is provided with a holding chamber (11), and an inner bottom of the holding chamber (11) is provided with a rotating groove (13) for the licking member (3) to rotate.

7. The slow-liquid-feeding bowl for pets according to claim 6, wherein a side wall of the inner bottom of said holding chamber (11) is provided with a plurality of circularly arranged placing ribs (12), and the placing ribs (12) are located at a side of the rotating groove (13).

8. The slow-liquid-feeding bowl for pets according to claim 1, wherein the licking compartment (2) has a frustum structure, a top of the licking compartment (2) is an inwardly concave structure forming a concave placing cavity (22) for holding liquid food, and the licking hole (21) is located at a bottommost end of the center of the licking compartment (2).

9. The slow-liquid-feeding bowl for pets according to claim 1, wherein the licking compartment (2) has a placing space (23) inside for accommodating the holding container (1), an inner wall of the placing space (23) is provided with a plurality of upper limit bosses (24) arranged at equal intervals and a plurality of lower limit bosses (25) arranged at equal intervals, the upper limit bosses (24) and the lower limit bosses (25) being alternately arranged with respect to each other, and an outer wall of the holding container (1) is provided with circular ribs (15) that are engaged with the plurality of upper limit bosses (24) and the plurality of lower limit bosses (25).

10. The slow-liquid-feeding bowl for pets according to claim 9, wherein a highest point of the top of the licking compartment (2) is provided with drainage holes (26) at the concave placing cavity (22), and the drainage holes (26) are located above the holding container (1).
